(19) United States
(12) Patent Application Publication
(10) Pub. No.: US 2008/0289380 A1
(43) Pub. Date: Nov. 27, 2008

(54) Pin Assembly

(75) Inventor: Lee David Blattmann, New South Wales (AU)

Correspondence Address: TELEZYGOLOGY, INC., 520 W. ERIE STREET, SUITE 210, CHICAGO, IL, 60654, US

(73) Assignee: TELEZYGOLOGY, INC., CHICAGO, IL (US)

(21) Appl. No.: 12/159,641

(22) PCT Filed: Dec. 29, 2006
(86) PCT No.: PCT/AU2006/001975

§ 371 Date: Jun. 30, 2008

Related U.S. Application Data
(60) Provisional application No. 60/754,920, filed on Dec. 29, 2005.

(51) Int. Cl. E05B 15/12

(52) U.S. Cl. 70/378

(57) ABSTRACT

The invention provides a pin assembly (10) useful for situations of high vibration, such as hatches or lockers on aircraft. Pin assembly (10) has a locking pin (12) adapted for insertion in a latching mechanism. Locking pin (12) has a maximum cross-section. Assembly (10) also includes a base (32) for locking pin (12) and at least one slip plate (20) which has an aperture (21) which is larger than the maximum cross-section of the locking pin (12).

### FIELD OF THE INVENTION

This invention relates to a pin assembly. While the pin assembly of the invention may have wide application in any door or lock situation, the description below will focus on fastener assemblies used in the aerospace industry, especially those found in storage compartments of airplanes. However, it is to be understood that the invention is not limited to this application.

### BACKGROUND OF THE INVENTION

Typical storage units in an airplane utilize mechanical or electro-mechanical locking mechanisms. The latch generally consists of a mechanism which engages a male pin or staple when the door is closed. In the closed position the latch remains engaged to the male portion. To release the door, a user simply lifts the latch handle or in the case of an electromagnetic latch presses a switch and the door is released. While these types of systems have been generally successful in keeping items stowed during travel, there have been problems. There is a considerable amount of movement between the door and the cabinet during flight which leads to alignment problems between the mechanism and the pin.

Because of this alignment issue, the latch requires considerable tolerances between the mechanism and the pin for successful closing before or during flight. This tolerance is responsible for the squeak and rattle during service. The need to accurately align the pin during assembly, so that it properly engages with the mechanism in use, is a time consuming task. Inaccurate alignment can cause the latch to malfunction, either failing to release or failing to close. This is particularly the case in electro-mechanical locks because of the limited amount of force the mechanism can apply to release from a misaligned pin.

### SUMMARY OF THE INVENTION

This invention aims to solve or at least alleviate the above-mentioned problems in a variety of ways. While this invention is able to work with newly built applications, it is also able to be directly retro-fitted to existing applications. In the instance of an aircraft storage unit, it is able to be retro-fitted to existing mechanical or solenoid pin attachment points at a typical mechanical or electromagnetic latch point with minimal site work and modification.

Accordingly, this invention provides a pin assembly including:
a locking pin adapted for insertion in a latching mechanism, the locking pin having a maximum cross-section;
a base for the locking pin, the base having a maximum cross-section; and
at least one slip plate including an aperture for receiving the locking pin, the aperture being larger than the maximum cross-section of the locking pin.

Preferably, the pin assembly of the invention includes a second slip plate which has an aperture for receiving the base for the locking pin, the aperture of the second slip plate being larger than the maximum cross-section of the base for the locking pin. The aperture of the first slip plate may be the same shape or a different shape from that of the second slip plate. Preferably, the shapes are different if the cross-sectional shapes of the locking pin and base are different.

Since the aperture in the first slip plate is larger than the maximum cross-sectional shape of the locking pin (and, if present, the aperture of the second slip plate is larger than the maximum cross-sectional shape of the base), the pin is able to move within the aperture (or apertures). Not only is the pin able to move into and out of the aperture (which, for the sake of clarity, will be referred to as a “vertical” movement), but the pin can also move side to side, forward and back, etc., within the limits of the aperture (or apertures). For the sake of clarity, this will be referred to as “horizontal” movement.

It is preferred that the pin assembly of the invention includes bias means for biasing the locking pin towards the locking mechanism. It is especially preferred that the bias means comprises a coiled spring. The pin assembly of the invention may be contained within a housing, with the pin protruding therefrom. When the bias means is included in the pin assembly, a compression plate may be used to compress components of the pin assembly within the housing. When the bias means is present, the locking pin is preferably capable of vertical movement with respect to the compression plate.

In an especially preferred embodiment, the pin assembly of the invention has a pin plate supporting the locking pin and the base. Preferably, the locking pin is integral with, mounted on or fixed to one side of the pin plate while the base is integral with, mounted on or fixed to the other side of the pin plate. In this embodiment, the pin assembly preferably includes both the first and second slip plates and the housing, together with the compression plate. It is preferred that a suitable number of fixing elements, such as bolts or screws, secure the compression plate, the first and second slip plates and the housing so that there is minimum “play” of the slip plate and compression plate in the housing. However, in this embodiment it is preferred that the pin plate included in the assembly is not restricted from horizontal and vertical movement with regard to the fixing elements. For this purpose, the pin plate may be provided with apertures or cut outs which are larger than the maximum cross-section of the fixing elements.

As will be apparent to one skilled in the art, the pin assembly of the invention can provide an adjustable, self-centering, self-aligning locking pin capable of fitting into a like-sized aperture containing the latching mechanism. In the instance of a storage unit in an aircraft, this locking pin can fit into an aperture on the storage unit for the purpose of holding the storage hatch door in the closed position.

It is evident to one skilled in the art that the locking pin in the assembly of the invention may have many forms, from multi-pins to ‘D’ shaped staples, etc.

The pin assembly of the invention may be described as friction based and able to move in vertical and horizontal directions. The locking pin may be regarded as frictionally clamped and may be designed to remain in any position it is set to unless it is forced to move into a new position by a lateral load. In the instance of the storage unit, depending on the load in the unit, the pin assembly may need to adjust to close properly. The pin assembly of the invention can allow for any adjustments that may be necessary in closing the hatch. The adjustment can be set to best suit the desired application.

In the especially preferred embodiment which includes the housing, the two slip plates and the compression plate, together with the bias means, it will be appreciated that the locking pin can be held in a desired position in the latching mechanism while still allowing the locking pin to move in a vertical and horizontal position as force demands. This controlled movement allows the squeak & rattle between the locking pin and mechanism to be minimized.

The locking pin can also include a manual release. When the manual release is activated the locking pin can be released from its corresponding aperture. This can be configured to allow release across the range of tolerance. To ensure safety, certain embodiments may require that a special tool be utilized in order for the manual release to work. This prevents unauthorized release of the locking pin.

Any suitable type of manual release may be used in the pin assembly of the invention. Preferably, the pin assembly includes a guide pin which fits into the base and locking pin and is able to be pushed through an aperture in the locking pin to manually disengage the latch mechanism if required. In this embodiment, the guide pin is sized so that in normal use it will not protrude through the locking pin sufficiently to disengage the latching mechanism. However, when manual release is required, the guide pin may be accessed, preferably using a special tool, and pushed through the aperture in the locking pin sufficiently to disengage the latching mechanism.

After manual release, the guide pin may be pushed manually back to its normal position in the pin assembly, which is thereby reset for normal use.

The housing in the preferred embodiment may be integrated into the hatch structure of the aircraft storage unit or into any other application utilizing existing methodologies. Depending on the application, varying methodologies may need to be employed to best suit the desired outcome.

When screws are used to secure the pin assembly of the invention, in cases of high vibration within a desired application, a thread locking compound may be utilized on the screws.

### BRIEF DESCRIPTION OF THE DRAWINGS

The invention will now be described in connection with a non-limiting example thereof as set out in the accompanying drawings. In the drawings:

FIG. 1 depicts an exploded view of the pin assembly;

FIG. 2 depicts the pin assembly in its assembled form; and

FIG. 3 depicts a side view of the pin assembly as it may be assembled within a component such as a storage unit of an aircraft.

### DETAILED DESCRIPTION OF THE PREFERRED EMBODIMENT

In the preferred embodiment of this invention, pin assembly 10 has a locking pin 12 capable of fitting into an aperture of like size (not shown) in a latching mechanism. Locking pin 12 is adjustable, self-centering and self-aligning.

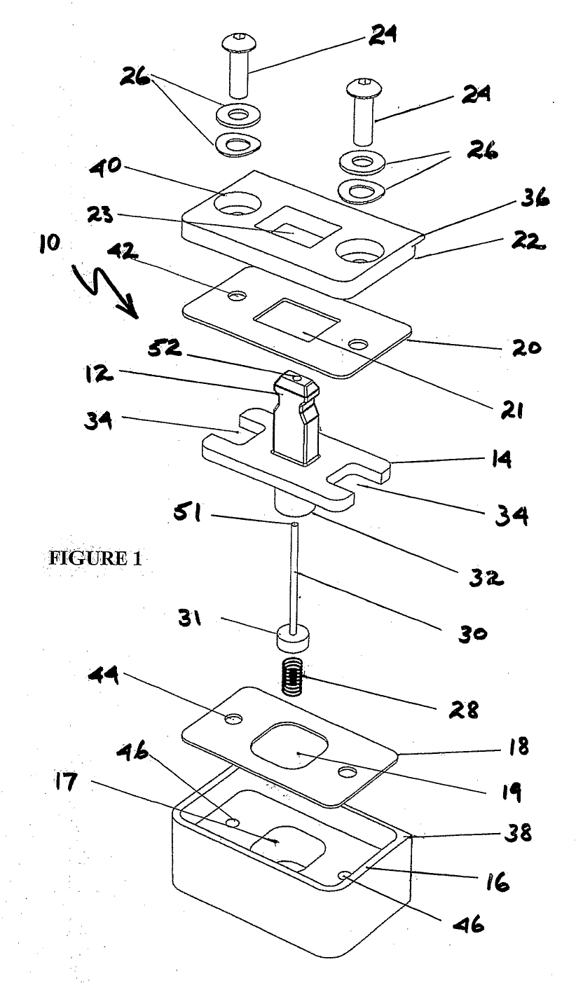

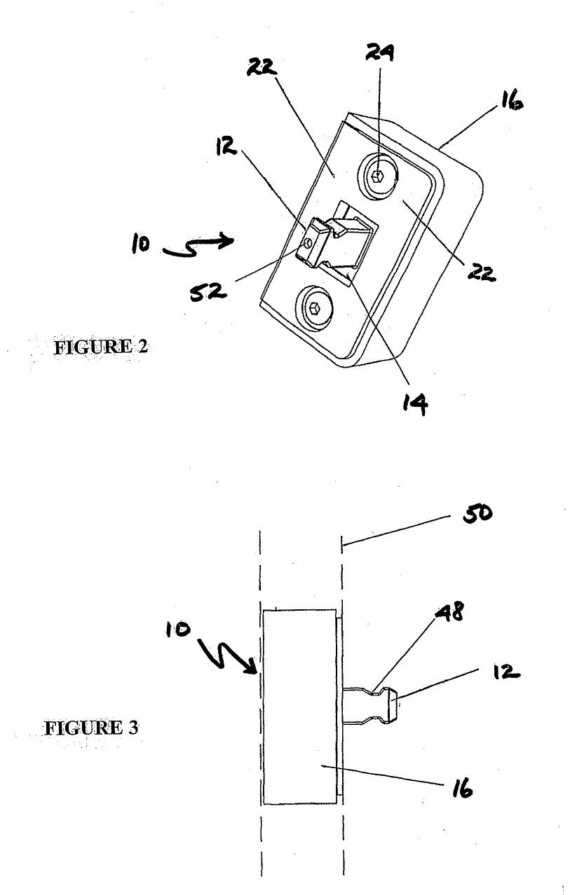

As shown in the exploded view of FIG. 1, pin assembly 10 has housing 16 which includes aperture or well 17. Housing 16 is designed to accommodate second slip plate 18 which has aperture 19. It will be noted that aperture 19 is larger than the maximum cross-section of base 32, so that base 32 can move around in aperture 19.

Spring 28 is designed to be seated in well 17 of housing 16 and to bear against head 31 of guide pin 30. Guide pin 30 passes through base 32 and into locking pin 12.

Locking pin 12 and base 32 are, in this embodiment, integral and are fixed into pin plate 14, so that there is no movement between locking pin 12, base 32 and pin plate 14. Pin plate 14 includes two cutouts 34.

First slip plate 20, having large aperture 21, is designed to sit on top of pin plate 14. It will be noted that aperture 21 is larger than the maximum cross-section of locking pin 12. Plate 14 can slip around between slip plates 18 and 20 in the final assembly and hence locking pin 12 is capable of “horizontal” movement within the confines of aperture 21.

Compression plate 22 is designed to sit on top of slip plate 20 with ledge 36 lying on rim 38 of housing 16.

Bolts or screws 24 are used to secure pin assembly 10. Bolts or screws 24 pass through washers 26, apertures 40 on compression plate 22, apertures 42 on slip plate 20, cutouts 34 on pin plate 14, apertures 44 on slip plate 18 and into apertures 46 in housing 16. It will be noted that apertures 40, 42, 44 and 46 snugly receive screws or bolts 24, but that cutouts 34 are much larger, to allow horizontal “play” of pin plate 14 with regard to screws or bolts 24.

Spring 28, exerting upward force on guide pin 30, allows locking pin 12 to be compressed towards housing 16 if required because of misalignment of the latching mechanism (not shown).

It will be noted that each of apertures 17, 19, 21 and 23 is large enough to permit “horizontal” movement at pin 12 within pin assembly 10.

Because locking pin 12 is able to move vertically or horizontally, depending upon the desired application, locking pin 12 can self-align and centre with the corresponding aperture (not shown) on the latching mechanism. Thus locking pin 12 can adjust and meet the aperture, instead of remaining rigid, perhaps causing a user to try and force the locking pin to meet the aperture. There is more allowance in aligning locking pin 12 with the aperture of the latching mechanism (not shown) than in the prior art.

As can be seen from FIG. 3, where pin assembly 10 is shown in situ in a hatch 50 (shown in dotted outline), pin 12 may be provided with a circumferential notch 48, which can be gripped by suitable means, such as teeth, in the latching mechanism (not shown).

It is optional to include a manual release with pin assembly 12. A manual release may be desirable in the case that locking pin 12 does not release from its corresponding aperture.

An embodiment of manual release is shown in the drawings, especially with reference to FIG. 1. It will be noted that guide pin 30 has base 31 which is circular in cross section. Base 31 can slide within base 32 as far as pin plate 14 but, because of its circular cross sectional shape, can travel no further towards locking pin 12. In normal use, there will be a gap between base 31 and pin plate 14 when guide pin 30 is inserted in base 32 and locking pin 12.

In normal use, the leading point 51 of guide pin 30 will be wholly contained within locking pin 12 or will protrude to a small extent through aperture 52 in locking pin 12—especially when locking pin 12 is pressed back into housing 16 against the bias of spring 28, because of latch misalignment, etc. Such small protrusion is insufficient to disengage the latch mechanism.

If it is necessary to manually disengage the latch mechanism, a pick or other suitable tool can be inserted in a hole (not shown) located in well 17 of housing 16, to push on base 31 of guide pin 30. Base 31 can be pushed to the maximum extent into base 32, so that point 51 protrudes through aperture 52 sufficiently to disengage the latch mechanism. For example, if the latch mechanism has teeth gripping notch 49 in the locked position, the latch mechanism can be designed so that point 51 can cause the teeth to disengage.

### INDUSTRIAL APPLICABILITY

The pin assembly of the invention is useful to overcome the problems presented by misalignment encountered from vibration, especially in aircraft.

1. A pin assembly including:
a locking pin adapted for insertion in a latching mechanism, the locking pin having a maximum cross-section;
a base for the locking pin, the base having a maximum cross-section; and
at least one slip plate including an aperture for receiving the locking pin, the aperture being larger then the maximum cross-section of the locking plate.

2. The pin assembly of claim 1, which includes a second slip plate including an aperture for receiving the base for the locking pin, the aperture of the second slip plate being larger then the maximum cross-section of the base for the locking pin.

3. The pin assembly of claim 2, wherein the aperture of the one slip plate is a different plate from the aperture of the second slip plate.

4. The pin assembly of claim 1, which includes bias means for biasing the locking pin towards the latching mechanism.

5. The pin assembly of claim 4, which further includes a compression plate.

6. The pin assembly of claim 1, wherein the locking pin is mounted on one side of the pin plate and the base is mounted on the other side of the pin plate.

7. The pin assembly of claim 1, which further includes a housing.

8. The pin assembly of claim 4 wherein the bias means is a coiled spring.

9. The pin assembly of claim 1 which further includes a guide pin for insertion in the base of the locking pin.

10. A pin assembly including:
a locking pin adapted for insertion in a latching mechanism, the locking pin having a maximum cross-section;
a pin plate supporting the locking pin;
a base supported by the pin plate, the base having a maximum cross-section;
a first slip plate including an aperture for receiving the locking pin, the aperture being larger than the maximum cross-section of the locking pin;
a second slip plate including an aperture for receiving the base, the aperture being larger then the maximum cross-section of the base;
bias means for biasing the locking pin towards the latching mechanism;
a compression plate; and
a housing for housing the second slip plate, the bias means, the base, the pin plate, the first slip plate and the compression plate.

11. The pin assembly of claim 10 wherein the bias means is a coiled spring.

12. The pin assembly of claim 10, which further includes a guide pin for insertion in the base of the locking pin.

13. The pin assembly of claim 12, wherein the guide pin is adapted to protrude through an aperture in the locking pin.

14. The pin assembly of claim 13, wherein the guide pin is adapted to disengage the latch mechanism when the guide pin is caused to protrude through the aperture in the locking pin to a chosen extent.
